(19) United States
(12) Patent Application Publication
(10) Pub. No.: US 2013/0263608 A1
(43) Pub. Date: Oct. 10, 2013

(54) CRYOGENIC STORAGE DEVICES

(71) Applicant: David Thornton-Wood, Hatherleigh Devon (GB)

(72) Inventor: David Thornton-Wood, Hatherleigh Devon (GB)

(73) Assignee: QUANTUM PRODUCTION LIMITED, Worminghalll Buckinghamshire (GB)

(21) Appl. No.: 13/823,376

(22) PCT Filed: Sep. 14, 2011
(86) PCT No.: PCT/EP2011/065969

§ 371 Date: Jun. 27, 2013

(30) Foreign Application Priority Data
Sep. 14, 2010 (GB) 1015315.3
Sep. 14, 2010 (GB) 1015317.9
Sep. 14, 2010 (GB) 1015318.7

(51) Int. Cl. F17C 5/02

(52) U.S. Cl. CPC F17C 5/02
USPC 62/49.1; 220/560.12; 62/50.1; 219/438; 62/49.2

(57) ABSTRACT

A cryogenic device is disclosed which has a cryogenic chamber, temperature sensor, a liquid cryogen injection zone, a source of heat, and a controller, in response to temperature data obtained from the temperature sensor, the injection of liquid cryogen into the injection zone and the application of heat, to control the temperature in the cryogenic chamber. The device may utilise a second source or a higher temperature gas as the source of heat and may utilise a multilayered plate insulator between the injection sites for cryogen and the cryogenic chamber. The device may also incorporate an overflow monitoring system and/or an automated cryogen filling system.

### FIELD OF INVENTION

The present invention relates generally to cryogenic storage devices and, more particularly, to a cryogenic storage devices using liquid cryogen.

### BACKGROUND ART

There are many previously known cryogenic storage systems and freezer systems. Cryogenic storage systems, which utilise liquid cryogens and their vapour, are typically operated to ensure that a certain threshold temperature is not breached during use. There are various forms and designs of cryogenic storage device known in the art. One particularly effective and widely used range of devices utilise liquefied gaseous materials as the cryogen. In a first arrangement these devices are typically cylindrical in shape, having a closed bottom and open top thus defining a chamber, which is referred to as the cryogenic freezing chamber. In one arrangement a source of cryogen, typically liquid nitrogen, is fluidly connected to the interior of the chamber through a valve system so that the liquid level within the cryogenic chamber is maintained within predetermined limits, but below the level of storage of the biological specimens to be frozen. A lid is usually located across the open top of the cryogenic tank. In this arrangement the cryogen vapour fills the chamber above the liquid cryogen resulting in freezing of the specimens.

In a second arrangement the cryogenic storage device comprises a tank having an open top and a wall which defines an interior chamber adapted to receive biological specimens, the wall is generally cylindrical in shape and closed at its lower end. A fluid reservoir is disposed around at least a portion of the wall on an outer surface of the wall. This reservoir is adapted to receive a, cryogen, such as liquid nitrogen. Cryogen vapour is also permitted to vent from the liquefied gaseous material contained within the reservoir into the interior chamber. A lid is usually located across the open top of the cryogenic tank. In this arrangement the cryogen is located around a large exterior surface of the interior chamber within the fluid reservoir and cryogen vapour may fill the interior chamber through vents towards the top of the fluid reservoir that are in fluid communication with the interior chamber. Enabling cryogen vapour to pass through the vents and into the interior chamber. In this arrangement the interior chamber is effectively cooled by the action of the envelope of cryogen around the chamber in addition to the cryogen vapour entering the interior chamber. In this arrangement the top surface of the cryogen is located at a height above at least a proportion of the specimens in the interior chamber. An example of this arrangement is provided in published European Application EP 1206668 A.

In a third arrangement similar to that in the preceding paragraph the fluid reservoir is arranged such that it forms an envelope of cryogen around the interior chamber but with this arrangement there are no vents and there is no fluid communication between the fluid reservoir and the interior chamber. The cooling effect is simply due to the cryogen envelope surround the interior chamber. The temperature in the interior chamber may be controlled by adjusting the level of cryogen in the fluid chamber.

With these arrangements biological specimens, such as blood, semen or other types of biological specimens, are placed within the cryogen freezing chamber or interior chamber. Since the temperature of the cryogen, typically liquid nitrogen, is extremely low, e.g. below −191° C., the viability of the biological specimens can be maintained for long periods of time. The typical temperature range required in these cryogenic freezers is between −135° C. and −190° C. and usually −150° C. or −190° C. The temperature of the interior chamber may be controlled by altering the level of the cryogen in the chamber or a fluid reservoir.

Whilst these cryogenic storage devices are in widespread use they have a number of disadvantages. One disadvantage is that these arrangements provide a high level of temperature variation between the top and bottom of the interior vessel. Temperature control is problematic and can change relatively quickly with changes in cryogen level in the fluid chamber; level detection and adjustment is the means of temperature control in these devices.

A further disadvantage observed in these arrangements is where the liquid cryogen may come into contact with the biological specimens. In these circumstances the biological specimens would become immersed within the liquid cryogen and cross contamination between the biological specimens is possible. For example, in the event that a biological specimen leaks into the liquid cryogen, impurities, diseases, viruses or the like that may be contained within that biological specimen may be transmitted to a different biological specimen also contained within the cryogenic freezing device. Many biological specimen preparations are not designed to be stored in contact with cryogenic liquid. The security and integrity of biological specimens if of the utmost priority in many biological cryogenic storage facilities and any cross-contamination could have serious consequences for the facility and those who rely on sample integrity e.g. patients. Various attempts have been proposed to address this problem such as the solution described in published International Patent Application WO2008009840 A1. But none have proved totally satisfactory.

In those arrangements where only cryogen vapour, rather than liquid cryogen, is contained within the sample area of the interior chambers of the tank, cross contamination of the biological specimens is rendered virtually impossible. However, there is the possibility of overfill or overflow from the cryogen liquid location into the sample chamber. This can occur when the sensor dedicated to indicating the top level of liquid cryogen in the device fails and therefore does not cut-off the supply of liquid cryogen to the device.

In addition in all arrangements there is the possibility that the sensor, when present, dedicated to indicating the minimum acceptable lower level of cryogen may fail and thus the refill with liquid cryogen is not initiated at this point resulting in temperature rise in the chamber and sample damage or loss.

As an example liquid nitrogen cryogenic storage systems will typically be operated to maintain the temperature below −150° C. It is of relatively little concern to the operators if the temperature is significantly lower than −150° C. as long as it does not go higher. Consequently the temperature monitoring and control systems in such storage systems are generally limited in their function to achieve this result. Often samples are frozen before they are placed into the cryogenic storage facility. One disadvantage is that these arrangements provide a high level of temperature variation between the top and bottom of the interior vessel. It is difficult to operate such cryogenic storage systems under isothermal conditions and to control the temperatures within the cold storage areas. They have an advantage in that on failure of the cryogen liquid feed there may be a reasonable period of time before the temperature rises above the threshold in the storage area, thus providing some time for remedial action. In addition these cryogenic freezers are difficult to operate and control at higher temperatures above −135° C.

Conventional freezers as a class of cold storage device are generally mechanical in nature and typically operate at higher temperatures than cryogenic storage systems. Typically from −20 to −150° C. and usually operate at around −80° C. These systems typically utilise a mechanical refrigeration cycle with refrigerants such as liquid ammonia, which is highly toxic. This consists of a refrigeration cycle, where heat is removed from a low-temperature space or source and rejected to a high-temperature sink with the help of external work, hence the term “mechanical freezer”. Because these freezers have a mechanical cooling cycle they may be controlled to an isothermal condition at a variable temperature from within a desired temperature range. More or less work is applied to the cycle and this can be utilized to provide a degree of accuracy in temperature control. However, these mechanical freezers are expensive to run, consume a huge amount of electricity (which increasingly becomes a major issue in today's green environment where people strike to conserve rather than waste energy) and offer no protection in the event of a power failure, with only hours to find alternative storage solutions before warming up renders samples unusable.

In those cryogenic storage arrangements where only cryogen vapour, rather than liquid cryogen, is contained within the cryogenic chamber whilst cross-contamination of the biological specimens is reduced with certain designs there is the possibility of overfill or overflow from the cryogen liquid location into the sample chamber. This can occur when the sensor dedicated to indicating the top level of liquid cryogen in the device fails and therefore does not cut-off the supply of liquid cryogen to the device.

### SUMMARY OF THE PRESENT INVENTION

The present invention provides a cryogenic refrigeration/storage device which addresses various shortcomings of the cryogenic storage devices and/or mechanical freezers in the art.

In a first aspect of the present invention a cryogenic storage device is based on utilising liquid cryogen as the cooling medium and improving the temperature control within a cryogenic chamber through insulation of that chamber from the location of and contact with liquid cryogen within the device and/or the liquid cryogen injection point within the cryogenic device via use of an insulating system preferably a multi-layered plate insulation system. The use of the insulating system enables improved temperature control and distribution within the cryogenic chamber affording more isothermal conditions within the chamber compared to a conventional cryogenic storage devices which do not utilise the insulating system such as for example the multi-layered plate insulation of the present invention.

In addition the cooling system may utilise a low energy source of heat in order to provide more control in adjusting and maintaining the desired temperature and temperature distribution within the cryogenic chamber.

Thus according to a first aspect of the present invention there is provided a cryogenic device comprising a cryogenic chamber, a liquid cryogen reservoir and/or an injection zone for liquid cryogen, separated by an insulator. It is preferred that the insulator is a multi-layered plate insulator comprising two or more plates.

In a typical embodiment the physical structure of the cryogenic device of the present invention and supporting equipment will be similar to existing −150/−190° C. liquid cryogen based cryogenic storage devices, but with important modifications.

Thus in one embodiment the cryogenic device of the present invention comprises a vessel having an open top and closed at its lower end, a cryogenic chamber having an open top and closed at its lower end adapted to receive biological specimens, the cryogenic chamber being located within the vessel, a liquid cryogen reservoir located within the vessel and beneath the cryogenic chamber, the cryogenic chamber being separated from liquid cryogen reservoir by an insulator and preferably a multi-layered plate insulator comprising two or more plates. In a preferred embodiment the vessel is a multi-walled and has a vacuum between at least two of the walls providing thermal insulation for the cryogenic device from the exterior ambient environment.

This arrangement defines a fluid chamber disposed between the inner wall of the vessel and the outer wall of the cryogenic chamber, which may in one embodiment, be in fluid communication with the liquid cryogen reservoir and the interior of the cryogenic chamber. In use the liquid cryogen within the reservoir evaporates and passes from the liquid cryogen reservoir through the fluid chamber and into the cryogenic chamber. The liquid cryogen vapour cools the exterior of the cryogenic chamber exposed to the fluid chamber and the interior of the cryogenic chamber. In a further embodiment although there is a liquid cryogen reservoir the fluid chamber is not in fluid communication with the interior of the cryogenic reservoir, the fluid chamber being closed at its top with venting of cryogen vapour to the exterior of the device.

A preferred embodiment does not utilise liquid cryogen storage as such within the cryogenic device and therefore does not require a reservoir as such for the storage of a liquid cryogen reservoir within the device. In this embodiment the liquid cryogen is injected under controlled conditions into a liquid cryogen zone, where only a small amount of liquid cryogen will be present, the major portion of the liquid cryogen being present as cryogen vapour. Thus in this embodiment the cryogenic device comprises a vessel having an open top and closed at its lower end, a cryogenic chamber having an open top and closed at its lower end adapted to receive biological specimens, the cryogenic chamber being located within the vessel, a liquid cryogen injection zone located within the vessel and beneath the cryogenic chamber, the cryogenic chamber being separated from the liquid cryogen injection zone by an insulator preferably a multi-layered plate insulator comprising two or more plates. In a preferred embodiment the vessel is a multi-walled and has a vacuum between at least two of the walls providing thermal insulation for the cryogenic device from the exterior ambient environment.

In a further embodiment the device comprises a liquid cryogen reservoir and a liquid cryogen injection zone.

The insulator preferably a multi-layered plate insulator comprising two or more plates, being located between the liquid cryogen reservoir and/or the liquid cryogen injection zone, and the base of the cryogenic chamber, moderates the cooling effect of the liquid cryogen and/or liquid cryogen vapour on the base of the cryogenic chamber.

When present the opening at the top of the fluid chamber is in effect a vent enabling cryogen vapour to escape from the liquid cryogen reservoir and/or liquid cryogen injection zone and to enter the cryogenic chamber. This region of the cryogenic device may be modified to direct the flow of cryogen vapour out of this venting region downwards and into the interior of the cryogenic chamber.

In this arrangement cooling is imparted to the cryogenic chamber through the cryogen vapour and the cooling effect of cryogen vapour on the exterior walls of the cryogen chamber with the bottom of the cryogen chamber being insulated. When the vent is not present cooling is effected by contact of the cryogen vapour with the exterior wall of the cryogen chamber. The cryogenic chamber may be and preferably is removable.

The insulator may be made of any material with a thermal conductivity lower than the thermal conductivity of the material comprising the cryogenic chamber or may, by its construction or form, optionally in addition to material choice, may provide an insulating effect. It is preferred that the insulator is a multi-layered plate insulator comprising two or more plates that are separated from each other at a fixed distance using non-conductive spacers. These spacers may be made of any material that has low or virtually no thermal conductivity preferred examples include Bakelite® or PTFE. Preferably the plates are made of metal such as steel or aluminium and most preferably the metal is aluminium. In a preferred embodiment the top surface of each of the plates is matt and the bottom surface of each of the plates is polished. The multi-layered plate insulator may comprise from 2 to 8 plates, preferably 2 to 5 plates. The distance between the plates may be identical or different. Preferably the distance between each plate is identical and fixed. The distance between the plates may be from 1 to 20 mm, preferably, 1 to 16 mm, more preferably 2 to 10 mm and most preferably 4 to 10 mm. Although the multi-layered plate insulator comprises metal plates, which may have the same thermal conductivity as the walls of the cryogenic chamber, the form of this arrangement with gaps between the plates provides the required insulating properties.

It is preferred that the cross-sectional shape of the vessel, cryogenic chamber and insulator e.g. multi-layered plate insulator are the same, preferably circular so that the vessel, cryogenic chamber and insulator are cylindrical. In a further embodiment they may have different shapes save that the shape of the cryogenic chamber and insulator are such that they may both be accommodated within the interior of the vessel.

In a preferred embodiment there is a support plate located immediately below the cryogenic chamber and above the insulator e.g. top insulation plate of the multi-layered plate insulator. This support plate supports the cryogenic chamber and further separates it from the liquid cryogen reservoir and/or liquid cryogen injection zone.

The insulator e.g. multi-layered plate insulator may further comprise an integral stand, which functions to maintain the bottom of the insulator e.g. insulator plate above the bottom/floor of the vessel. The stand, in ensuring that the bottom of the insulator is raised above the floor of the vessel, assists in some embodiments in defining the liquid cryogen reservoir and/or liquid cryogen injection zone within the cryogenic device of the present invention. Thus in one embodiment the stand comprises a plate of similar dimensions to the bottom insulator plate but separated from the plate by spacers that are insulating spacers. The distance between the stand plate and the bottom plate of the multi-layered plate insulator is preferably much larger than that between the insulator plates. The key distinction is that the support plate is located below the level of liquid cryogen when a liquid cryogen reservoir is defined and/or is below the liquid cryogen injection point when a liquid cryogen injection zone is defined. The stand may simply comprise supporting legs and may in some embodiments be free standing, with the insulator e.g. multi-layered plate insulator simply resting on the stand or secured to it.

In a second aspect the present invention provides a cryogenic device having integrated monitoring of temperature within the cryogenic chamber and related control of the injection of liquid cryogen and application of heat to the device, to control the temperature of the cryogenic chamber, which in a preferred embodiment is used in combination with the multi-layered plate insulator.

Thus according to a second aspect of the present invention there is provided a cryogenic device comprising a cryogenic chamber, temperature measuring means, a liquid cryogen injection zone, a source of heat, and means for controlling, in response to temperature data obtained from the temperature measuring means, the injection of liquid cryogen into the injection zone and the application of heat, to control the temperature of the cryogenic chamber.

Thus the cryogenic device in this aspect further comprises a heating source for providing heat to the interior of the vessel and indirectly or directly to the cryogenic chamber. In one embodiment the heat source may be incorporated into the support plate as a low current resistive device. In an alternative embodiment the heat source may comprise the use of a different liquid cryogen and/or gas supply to the vessel that may be injected to the vessel at a different temperature than that of the primary liquid cryogen. In a preferred embodiment the heating source comprises a low current resistive device or similar in combination with the use of a different liquid cryogen and/or gas supply.

In the cryogenic chamber when there is a variation in temperature, because of the nature of the cooling method, this will often be manifested as a temperature gradient from low to high temperature from the bottom of the cryogenic chamber. This in part dictates the location of the heating source proximate to the bottom of the cryogenic chamber.

The function of these heat sources is to provide compensating heating control to allow fine tuning of temperatures within the cryogenic chamber. The energy used by these heat sources is very small in comparison to that used in a conventional mechanical freezer. The bulk of the temperature control within the cryogenic chamber is provided by the primary liquid cryogen, which is mostly in the vapour phase within the cryogenic device. These additional higher temperature heat sources work in combination with the bulk cooling effect of the primary lower temperature vapour phase liquid cryogen to fine tune the temperature within the cryogenic chamber. Thus the balance of injection of liquid cryogen and higher temperature gases may be used to provide the desired temperature within the fluid chamber to impart cooling to the exterior of the cryogenic chamber, with or without additional heat from the electrical heat source. When there are no higher temperature gases used the control is achieved by balancing the primary liquid cryogen injection with application of heat through the electrical heater.

In those embodiments of the present invention where liquid cryogen is injected into an injection zone it is preferred that the injection is provided by means of a proportional injection valve. This proportional injection valve will operate under the control of an electronic control system, which has as a major data input temperature readings from within the cryogenic device and in particular the cryogenic chamber. The control unit may be programmed with required temperature profiles for the cryogenic device and data concerning the amount of liquid cryogen to be injected into the cryogenic device depending in the nature of the liquid cryogen. Different liquid cryogens have different cooling effects and properties. Given a particular temperature and liquid cryogen the proportional valve is controlled to dispense the required amount of liquid cryogen into the cryogen injection zone to adjust the temperature of the device. The controller will also coordinate cryogen injection with the additional heat control means to achieve temperature control in the device. One example of a suitable proportional valve is a combination of a standard cryogenic valve, with a valve actuator, preferably a pneumatic actuator, more preferably a Scotch Yoke based actuator, and a valve positioner, preferably a pneumatic valve positioner, and more preferably a positioner using the force balance principal through a diaphragm spring arrangement. An example of a suitable actuator is the RC200 range of actuators, manufactured and sold by Remote Control a division of Rotork PLC, Brassmill Lane, Bath, BA1 3JQ, UK. An example of a suitable positioner is the P5/EP5 PMV valve control system as manufactured and sold by Palmstierna International AB, Korta Gatan 9, SE-171 54 SOLNA, Sweden.

This valve arrangement is used to inject the required amount of liquid cryogen automatically determined by an electronic automatic control system. This supply valve provides precision control of the velocity and quantity of liquid cryogen dispensed into the liquid cryogen injection zone, based on the temperature detected in the cryogenic chamber. The electronic controls will allow the user to set the temperature required within the cryogenic chamber by using control of amount of liquid cryogen injection and control of the additional heating elements within the cryogenic device.

When used the secondary source of injected cryogen and/or higher temperature gas may be controlled using a similar proportional valve arrangement.

The cryogenic chamber preferably comprises at least two integrated temperature sensors. There may be more than two. These are located at the bottom and the top of the cryogenic chamber. This enables operators to utilise a monitoring system to view the two extremities of storage temperatures within the chamber. This temperature monitoring may be the integral part of an automatic liquid cryogen filling system in addition to the control of temperature within the cryogenic chamber.

Thus according to a third aspect the present invention provides a method of refrigeration or freezing, which comprises monitoring the temperature within a cryogenic device comprising liquid cryogen injection means and a heat source and using the temperature monitoring to control the relative amount of liquid cryogen injected and heat to be applied to the cryogenic device in order to adjust the temperature within the cryogenic device to a desired value.

In a further embodiment the cryogenic device of the present invention, when utilizing a reservoir of liquid cryogen, comprises an intelligent liquid cryogen level control monitor. In a preferred embodiment this level control monitor is an integral part of an automated level control system in accordance with the fourth aspect of the present invention.

In a fourth aspect of the present invention a level control monitor comprises at least one level sensor located within the vessel of the cryogenic device. If the volume of liquid cryogen in the vessel exceeds a predetermined level this will be detected by the level sensor, which in conjunction with the automated filling system will shut off the supply of liquid cryogen to the reservoir within the cryogenic device. The level monitor may also comprise a low level sensor, which detects if the volume of liquid cryogen within the reservoir is below a predetermined minimum level and in conjunction with the automated filling system will turn in the supply valve to fill the reservoir with liquid cryogen. The back-up system of auto fill will allow continuous operation in the event of a mains failure for a minimum of seven days. In addition the temperature sensors and level sensors may be utilised in a system for the intelligent control of cryogen level within the cryogenic device through the integrated use of both temperature and level sensing technologies to simultaneously monitor both as critical liquid cryogen filling parameters. Both sensing systems can operate independently of each other and in this arrangement offer the maximum security and guarantee in maintaining the optimum cryogen liquid fill throughout operation of the cryogenic device and therefore high levels of security and guarantee in maintaining the required temperature within the device and therefore sample integrity. The system stop fill action is limited to control by the level sensor. This system may and preferably does co-operate with the control system for the heating source or sources in temperature control. In this arrangement the temperature, cryogen level, and heat source actuation are coordinated to provide optimum temperature control within the cryogenic chamber and maintenance of the isothermal conditions.

Thus in a fourth aspect the present invention provides an automated cryogen filling system, which comprises means for controlling the flow of cryogen from a cryogen store into a cryogenic device, temperature sensing means for sensing the temperature within a cryogenic device, cryogen level monitoring means for detecting the level of cryogen within the cryogenic device, and means for actuating the flow control means in response to data obtained from the temperature sensing means or cryogen level monitoring means. Optionally with the addition of heating control means, which is actuated in response to data obtained from the temperature sensing means and/or cryogen level monitoring means.

The present invention in this aspect further provides a cryogenic storage device comprising an automated cryogen filling system, which comprises means for controlling the flow of cryogen from a cryogen store into a cryogenic refrigerator, temperature sensing means for sensing the temperature within a cryogenic refrigerator, cryogen level monitoring means for detecting the level of cryogen within a cryogenic refrigerator, and means for actuating the flow control means in response to data obtained from the temperature sensing means or cryogen level monitoring means.

The automated cryogen filling system of this aspect may be utilised with a variety of cryogen storage device arrangements as described above in relation to the background art or any other aspect of the present invention.

Thus in one embodiment of this aspect the cryogen storage device comprising an automated cryogen filling system comprises a tank having an open top and a wall which defines an interior cryogenic freezing chamber, preferably cylindrical in shape, adapted to receive biological specimens, means for supporting biological samples within the chamber above the floor of the chamber, a source of cryogen, typically liquid nitrogen, fluidly connected to the interior of the chamber, and means for introducing the cryogen, preferably through a suitable valve system, to provide a liquid cryogen level within the chamber that is below the level of storage of the biological specimens to be frozen. Preferably the cryogen storage device comprises a lid located across the open top of the tank. In this arrangement the cryogen vapour fills the chamber above the liquid cryogen resulting in freezing of the specimens. Cooling is also in part provided through contact of the liquid cryogen with the chamber walls.

Thus in a further embodiment of this aspect the cryogen storage device comprising an automated cryogen filling system, comprises an interior chamber and a fluid reservoir arranged such that it forms an envelope of cryogen around the interior chamber such that there is no fluid communication between the fluid reservoir and the interior chamber, a source of cryogen, typically liquid nitrogen, fluidly connected to the interior of the fluid reservoir, and means for introducing the cryogen, preferably through a suitable valve system, to provide a liquid cryogen level within the fluid reservoir that may be above or below the level of storage of the biological specimens to be frozen within the chamber. Preferably the cryogen storage device comprises a lid located across the open top of the chamber. In this arrangement the cooling effect is simply due to the cryogen envelope in the fluid reservoir surrounding the interior chamber; there is no vapor cooling of the samples. The temperature in the interior chamber may be controlled by adjusting the level of cryogen in the fluid chamber, which vents outside of the interior chamber.

In a preferred embodiment of this aspect the cryogen storage device comprising an automated cryogen filling system, comprises a tank having an open top and a wall, preferably generally cylindrical in shape and closed at its lower end, which defines an interior chamber adapted to receive biological specimens, a fluid reservoir disposed around at least a portion of the wall on an outer surface of the wall and adapted to receive a liquid cryogen, such as liquid nitrogen, at least one, and preferably several, circumferentially spaced vents located proximate to the top of the interior wall to permit fluid communication between the fluid reservoir and the interior chamber of the storage device. The vents permit vapour from the liquid cryogen contained within the fluid reservoir to escape the reservoir and to enter the interior chamber. In this arrangement cooling is imparted to the chamber through the cryogen vapour and the cooling effect of liquid cryogen on the exterior walls of the chamber. Such a vent arrangement may be used with all aspects of the present invention.

In each of these arrangements the source of the liquid cryogen, such as liquid nitrogen, is fluidly connected to the chamber or fluid reservoir by a valve system which is controlled to maintain the level of the liquid cryogen in the chamber or reservoir within predetermined limits. Thus, when the level of the liquid cryogen falls below a lower limit, as detected by a low level sensor, the valve opens and fluidly connects the liquid cryogen from the source to the chamber or fluid reservoir thus raising the liquid level in the chamber or fluid reservoir to the predetermined required upper limit, as detected by an upper limit detector, or through calibration of the freezer. The amount of liquid cryogen being introduced in proportion to the calibration.

In each arrangement the temperature sensor may comprise a single sensor or a plurality of sensors located within the sample chamber of the cryogenic device.

In a further fifth aspect of the present invention, when significant quantities of liquid cryogen are present within the cryogenic device and when the fluid chamber has an open vent, the cryogenic device may further comprise a cryogen liquid overflow system. Preferably this system comprises a cryogen liquid overflow, which prevents cryogen liquid in excess of that required from accumulating in the cryogenic device, in fluid communication with an overflow chamber, which comprises liquid cryogen sensing means that provides a signal to a safety valve connected to the cryogen liquid feed means from the cryogen source to the cryogenic device.

Thus in a fifth aspect the present invention provides a cryogenic device comprising a cryogen liquid overflow system comprising a cryogen liquid overflow in fluid communication with an overflow chamber, which comprises liquid cryogen sensing means which in contact with liquid cryogen provides a signal to a safety valve connected to the liquid cryogen feed means between the liquid cryogen source and the cryogenic device.

Thus the cryogen liquid overflow prevents cryogen liquid, in excess of that required, from either accumulating in the cryogenic chamber or entering the cryogenic chamber from the fluid reservoir,

In use with a liquid cryogen reservoir if the liquid cryogen fill stop sensor fails the cryogen liquid passes from the cryogenic device into the cryogen liquid overflow, via the fluid chamber. The presence of liquid cryogen in the overflow chamber is detected by the sensor and the safety valve is actuated cutting off the supply of fresh cryogen to the cryogenic device. In this state the cryogenic device will be stable having essentially the required maximum fill of liquid cryogen for maintain the temperature below a maximum temperature within the device. Importantly, the excess liquid cryogen has been safely and effectively contained proximate to the cryogenic device and does not pose a safety hazard. In one embodiment it is preferred that the cryogen liquid sensor in the overflow chamber is associated with an alarm system to warn operators or monitors of the system that the fill sensor has failed resulting in a cryogen overflow event.

This early warning of cryogen overflow assists in ensuring that the samples within the faulty cryogenic device may be securely transferred in good condition to a fully functioning device before the faulty device fails completely resulting in sample loss and enabling timely repair of the faulty device.

It is to be understood that the various of aspects of the present invention described herein may be used alone or in combination with one or more of the other aspects described herein. Thus any combination of two or more of the aspects described herein may be used.

### BRIEF DESCRIPTION OF THE DRAWINGS

A present invention is exemplified and will be better understood upon reference to the following detailed description when read in conjunction with the accompanying drawing, wherein like reference characters refer to like parts throughout the several views, and in which:

FIG. 1 is a schematic section view illustrating a cryogenic device of the present invention incorporating the multi-layered plate as insulator;

FIG. 2 is a schematic sectional view illustrating an embodiment of the present invention with an overflow monitoring system;

FIG. 3 is a schematic section view illustrating a cryogenic device of the present invention incorporating temperature monitoring and control;

FIG. 4 is a schematic section view illustrating an embodiment of the automated cryogen filling system of the present invention;

FIG. 5 is schematic section view illustrating an embodiment of the automated cryogen filling system of the present invention in combination with an overflow;

FIG. 6 is schematic section view illustrating an embodiment of the automated cryogen filling system of the present invention in combination with a further overflow monitoring system; and

FIG. 7 is a schematic sectional view illustrating an overflow monitoring system according to the present invention.

### DISCLOSURE OF THE INVENTION

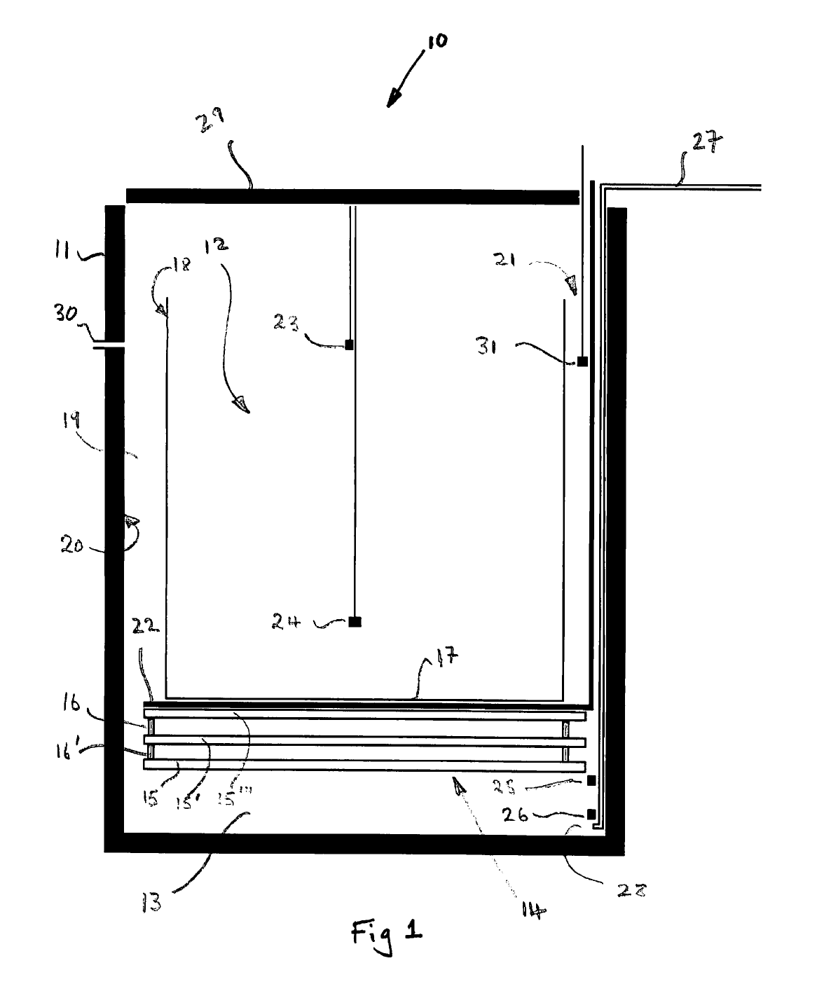

With reference to FIG. 1, there is exemplified a cryogenic device (10) comprising a vessel (11) which is generally cylindrical in shape, an cryogenic chamber (12) which is generally cylindrical in shape, a liquid cryogen reservoir (13), and a multi-layered plate insulator (14) having three plates (15, 15′, 15″), separated by insulating non-conductive spacers made of PTFE (16, 16′). The multi-layered plate insulator (14) is located between the cryogen reservoir (13) and the bottom (17) of the cryogenic chamber (12).

The cryogenic chamber (12) is adapted to receive biological specimens. Such biological specimens are inserted into and removed from the chamber (12) through the chamber and vessel open top and are held in conventional cryogenic storage trays and racks. The specimens are typically frozen prior to their insertion into the cryogenic chamber (12) although, optionally, the device (10) of the present invention can both freeze and store specimens. The vessel (11) is a double walled vessel (not shown) having a vacuum space within the walls.

The cryogenic chamber (12) is secured within the vessel (11) in such a fashion that its outer surface (18) defines a fluid chamber (19) with the inner wall (20) of the double walled vessel (11). This fluid chamber (19) extends entirely circumferentially around the sides of the cryogenic chamber (12). The fluid chamber (19) is open at its top (21) and is in fluid communication with the liquid cryogen reservoir (13) and enables fluid communication between the liquid cryogen reservoir (13) and the cryogenic chamber (12).

In use the liquid cryogen within or injected into the reservoir (13) evaporates and passes from the liquid cryogen reservoir (13) through the fluid chamber (19) and into the cryogenic chamber (12). The liquid cryogen vapour cools the exterior (18) of the cryogenic chamber (12) exposed to the fluid chamber (19) and the interior of the cryogenic chamber (12). The opening (21) at the top of the fluid chamber (12) is in effect a vent enabling cryogen vapour to escape from the liquid cryogen reservoir (13) and to enter the cryogenic chamber (12). This region of the cryogenic device (10) may be modified to direct the flow of cryogen vapour out of this venting region downwards and into the interior of the cryogenic chamber (12). In this arrangement cooling is imparted to the cryogenic chamber (12) through the cryogen vapour and the cooling effect of liquid cryogen on the exterior walls (18) of the cryogenic chamber with the bottom (17) of the cryogenic chamber (12) being insulated by the multi-layered plate insulator (14).

There is a support plate (22) immediately below the isothermal storage chamber (12) and above the top insulation disc (15″) of the multi-layered plate insulator (14). This support plate (22) supports the cryogenic chamber (12) and further separates it from the liquid cryogen reservoir (13). The support plate (22) comprises a low current resistive device (not shown) as a heating source.

The cryogenic chamber (12) has two integrated temperature sensors (23, 24). These are located at the bottom and the top of the isothermal storage chamber (12). This enables operators to utilise a monitoring system (not shown) to view the two extremities of storage temperatures within the cryogenic chamber (12). This temperature monitoring is an integral part of an automatic liquid cryogen filling system (not shown).

The device (10) further comprises cryogen liquid level sensors (25, 26) located within cryogen liquid reservoir region (13). The top sensor (25) sets the highest point for liquid cryogen within the reservoir (13). The lower sensor (26) sets the low point for cryogen within the reservoir. The temperature (23, 24) and cryogen reservoir level sensors (25, 26) and heating element within the support (22) are connected to an electronic monitoring and control unit (not shown), which is connected to a means (not shown) for actuating cryogen liquid flow control means (not shown) and heater control means (not shown) in response to data obtained from the temperature sensors (23, 24) and/or cryogen reservoir level sensors (25, 26). The flow control means controls the flow of liquid cryogen from a liquid cryogen storage unit (not shown) into the device (10) via liquid cryogen filling point (27), which fills the reservoir (13) from a point (28), which is below the level sensor (25). A similar arrangement may be envisaged when the reservoir (13) is a liquid cryogen injection zone; in this arrangement the sensors (25, 26) may be omitted as no significant amounts of liquid cryogen are present in the injection zone arrangement.

With reference to FIG. 1, a lid (29) is preferably disposed across the open top of the device (10) at all times except when biological specimens are introduced into or removed from the chamber (12). This lid (29), in the conventional fashion, may not form an airtight seal but allows a continuous flow of cryogen vapour from the chamber (12) to the exterior of the device (10). Alternatively it may provide a relatively tight seal with the body of the vessel (12) and include a small vent or valve for pressure equalisation between the interior of the device (10) and the exterior atmosphere.

The flow control means is primarily actuated whenever the fluid level in the reservoir (13) is below a predetermined amount as detected by the level sensor (26), and is shut off when the level in the reservoir (13) is returned to the required level as detected by level sensor (25). Thus, by selectively actuating and shutting off the flow control means and permitting the liquid cryogen material to flow from the storage unit (not shown) and to the reservoir (13) via filling means (27) the liquid cryogen level in the reservoir (13) is maintained between predetermined maximum and minimum amounts.

Also illustrated in FIG. 1 are fail safe features designed to protect the integrity of the biological samples stored within the chamber (12) of the device (10). The device incorporates an automated cryogen filling system, which is controlled by data obtained from the temperature sensors (23,24) and the cryogen reservoir level sensors (25,26), which can independently through a control unit signal actuation of the flow control means in response to data obtained from the temperature sensors (23,24) and/or the cryogen reservoir level sensors (25,26).

If the low level sensor (26) should fail or become faulty the level of liquid cryogen in the reservoir (13) could fall below the required levels and the temperature within the chamber (12) would rise putting the viability of biological samples at risk. In these circumstances the temperature detected by the temperature sensors (23,24) in the chamber (12) will have risen above the required temperature and this will cause the control unit for the flow control means to initiate filling of the reservoir (13) with liquid cryogen.

In addition the device (10) has an overflow (30) associated with the fluid reservoir (19) and a top level sensor (31), which ensures that overfill of liquid cryogen above the height of the fluid reservoir (19) into the chamber (12), which could occur on failure of level sensor (25) is not possible. It can be seen that the simple overflow (30) is located at a height above that of the level sensor (31) but below the top (21) of the fluid reservoir (19). If the sensor (25) fails liquid cryogen will fill the reservoir (13) and will pass into the fluid reservoir (19) and out of the overflow (30) before it reaches the top (21) of the reservoir (19) thus ensuring that no liquid cryogen may enter the chamber (12). The excess liquid cryogen passes out of the overflow (30) into the ambient environment.

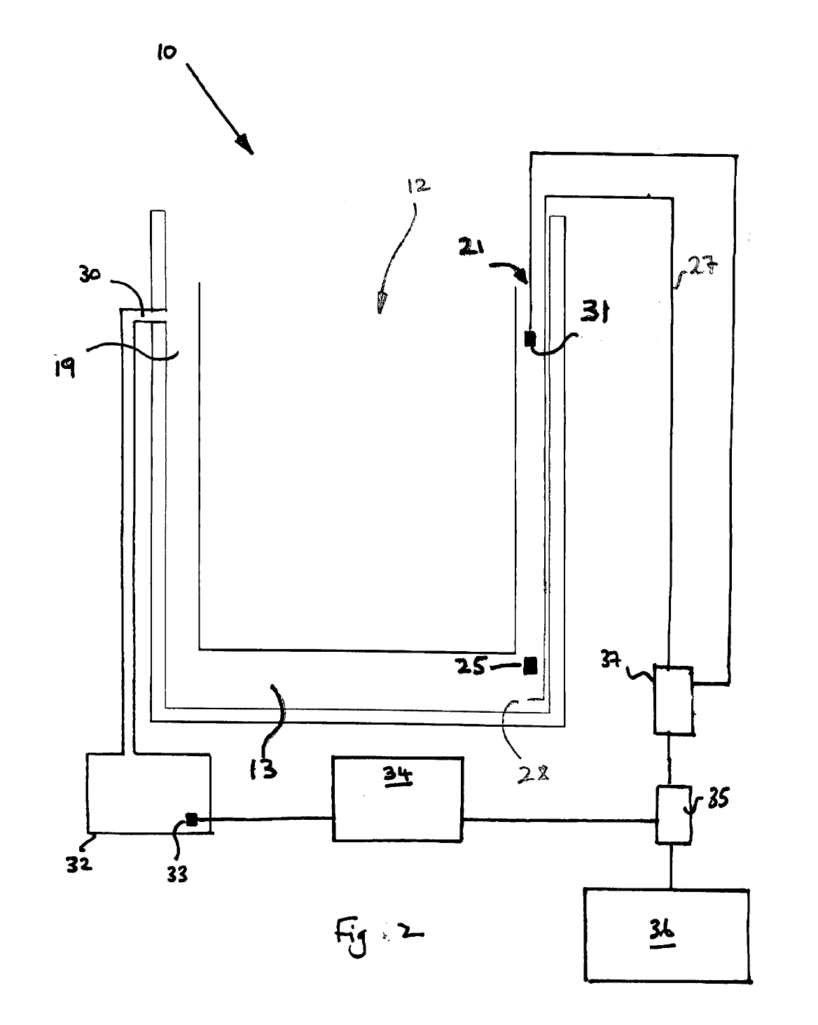

An overflow arrangement is illustrated in FIG. 2. In this arrangement the device (10) has an overflow (30) associated with the cryogen fluid reservoir (19), and a top level sensor (31). The other features of the device such as multi-layered plate insulator (14), temperature sensors (23, 24) and reservoir level sensor (26) and support plate (22) are not shown in this Figure for reasons of simplification, but are present in the device (10). The overflow (30) is located at a height above that of the level sensor (31) but below the top (21) of the fluid chamber (19). If the reservoir high level sensor (25) fails liquid cryogen will fill the fluid chamber (19) and will pass out of the overflow (30) before it reaches the top (21) of the fluid chamber (19) thus ensuring that no liquid cryogen may enter the cryogenic chamber (12). The cryogen liquid will pass through the overflow (30) and into an overflow chamber (32), which comprises a liquid cryogen detector (33). When liquid cryogen is detected by the detector (33) the signal from this sensor will, through an independent electronic control system (34), actuate an independent safety valve (35), which is connected to the liquid cryogen supply source (36) in order to safely shut off the supply of liquid cryogen through line (27) into the fluid reservoir (19) at point (28) within the device (10). The overflow electronic control system (34) acts independently of the normal control system (not shown) for the automated cryogen filling system, which fills the device (10) through shut off valve (37) under control from the temperature sensors (23,24) or the level sensors (25,26). A similar overflow arrangement may be envisaged when the reservoir (13) is a liquid cryogen injection zone; in this arrangement the sensors (25, 26) may be omitted as no significant amounts of liquid cryogen are present in the injection zone arrangement.

The independent electronic control system (34) preferably has an independent emergency power supply so that in the event of mains failure this system will continue to operate for a period of time after power failure, which may be as long as four weeks.

In a preferred embodiment activation of the cryogen liquid detector (33) and/or the independent safety valve (35) is associated with an alarm to alert operators or monitors of the system that the fill sensor has failed resulting in a cryogen overflow event.

Thus with this overflow system, even in the event of total overflow, the system will safely protect the biological samples from damage and contamination and, as importantly, will also protect the surrounding environment, personal and property within the vicinity of the cryogenic device from the liquid cryogen.

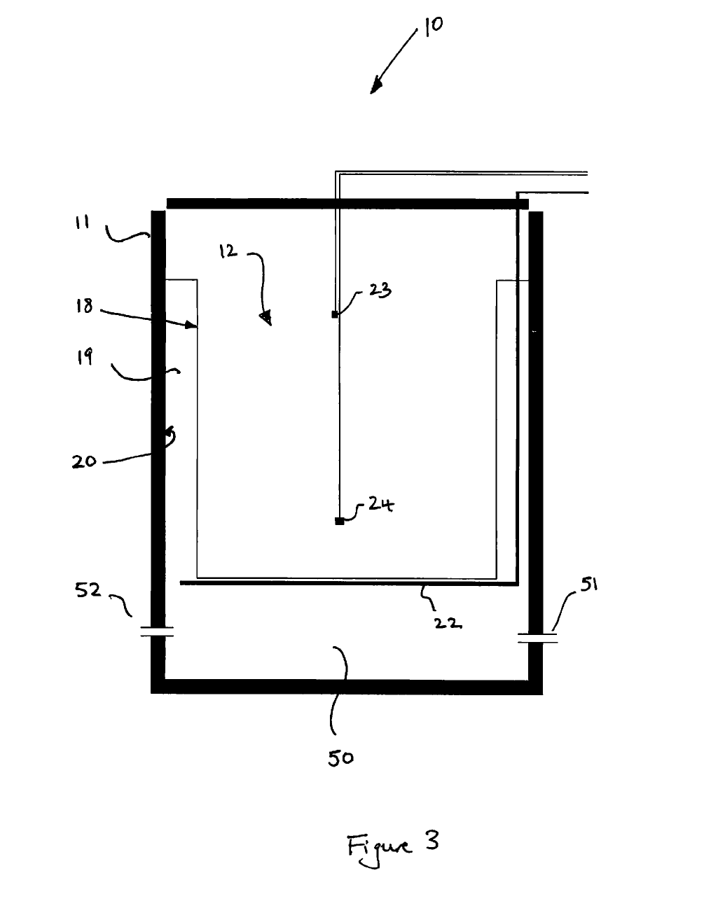

With reference to FIG. 3, there is exemplified a similar cryogenic device to that described in FIG. 1 but without the presence inter alia of a multi-layered plate insulator (14), sensors (25,26,31) and liquid cryogen feed (27). The cryogenic device (10) comprising a vessel (11) which is generally cylindrical in shape, an cryogenic chamber (12) which is generally cylindrical in shape, a liquid cryogen injection zone (50), a primary cryogen injection port (51) and a secondary cryogen/high temperature gas injection port (52).

The cryogenic chamber (12) is adapted to receive biological specimens. Such biological specimens are inserted into and removed from the chamber (12) through the chamber and vessel open top and are held in conventional cryogenic storage trays and racks. The specimens are typically frozen prior to their insertion into the cryogenic chamber (12) although, optionally, the device (10) of the present invention can both freeze and store specimens. The vessel (11) is a double walled vessel (not shown) having a vacuum space within the walls.

The cryogenic chamber (12) is secured within the vessel (11) in such a fashion that its outer surface (18) defines a fluid chamber (19) with the inner wall (20) of the double walled vessel (11). This fluid chamber (19) extends entirely circumferentially around the sides of the cryogenic chamber (12).

In use the primary liquid cryogen is injected into the liquid cryogen injection zone (50) via injection port (51) evaporates and fills the zone (50) and fluid chamber (19) with cryogen vapour. The secondary liquid cryogen (which is at a higher temperature than the primary liquid cryogen) or the higher temperature gas (higher temperature than the primary liquid cryogen) may be injected into the primary liquid cryogen injection zone (50) via injection port (52) and mixes with the primary cryogen vapour within the zone (50) and fluid chamber (19). The temperature (T3) within the zone (50) and fluid chamber (19), will be intermediate between the temperature (T1) of the primary liquid cryogen and the temperature (T2) of the secondary liquid cryogen or the higher temperature gas. If no primary liquid cryogen is injected than T3 will approximate to T2 if secondary liquid cryogen or the higher temperature gas is injected. If no secondary liquid cryogen or the higher temperature gas is injected then T3 will approximate T1 if primary liquid cryogen is injected. With all these possibilities T3 may be adjusted through the application of heat to device (10) via means of the action of heat from a low current resistive device (not shown) as a heating source located within the device (10) and in this example located within a support plate (22) immediately below the cryogenic chamber (12).

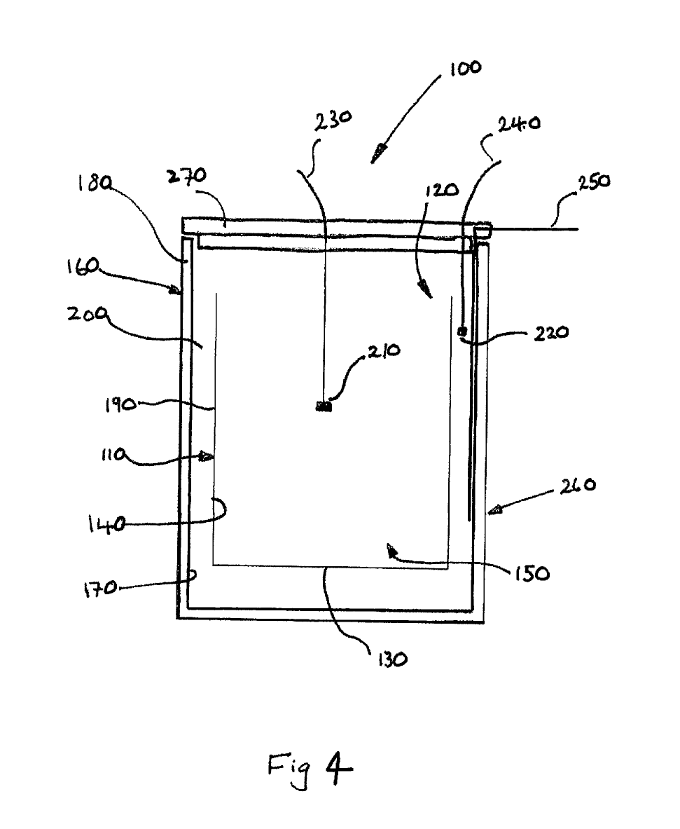

With reference to FIG. 4, there is exemplified a cryogenic storage device (100) including the automated cryogen filling system of the present invention. The cryogenic storage device (100) comprises a tank (110) which is generally cylindrical in shape. The tank (110) includes an open top (120) and a closed bottom (130).

The tank (110) includes an inner wall (140) which defines a generally cylindrical interior chamber (150) adapted to receive biological specimens. Such biological specimens are inserted into and removed from the chamber (150) through the open tank top (120) and are held in conventional cryogenic trays. The specimens are typically frozen prior to their insertion into the chamber (150) although, optionally, the device (100) of the present invention can both freeze and store specimens.

The tank (110) is secured (not shown) within a double walled container (160) having an inner wall (170) and a vacuum space (180). The tank (110) is secured in such a fashion that its outer surface (190) defines a space (200) with the inner wall (170) of the double walled container (160). This space (160) acts as a cryogen fluid reservoir. This reservoir (200) extends entirely circumferentially around the sides of the chamber (150) as well as the bottom (130) of the chamber (150).

The reservoir (200) is open at its top enabling fluid communication with the chamber (150). The device (100) further comprises a temperature sensor (210) located within the chamber (150) and in the vicinity of the biological specimens (not shown). The device also comprises a cryogen liquid level sensor (220) located within the reservoir (200) and located at a height required for the cryogenic liquid (not shown) when present in the reservoir (200). The temperature sensor (210) and the level sensor (220) are connected to an electronic monitoring and control unit (not shown) via connections (230 and 240), which is connected to a means (not shown) for actuating cryogen liquid flow control means (not shown) in response to data obtained from the temperature sensor (210) or cryogen level sensor (220). The flow control means controls the flow of liquid cryogen from a liquid cryogen storage unit (not shown) into the device (100) via liquid cryogen filling means (250), which fills the reservoir (200) from a point (260), which is below the level sensor (220).

With reference to FIG. 4, a lid (270) is preferably disposed across the open top (120) of the device (100) at all times except when biological specimens are introduced into or removed from the chamber (150). This lid (270), in the conventional fashion, may not form an airtight seal but allows a continuous flow of cryogen vapour from the chamber (150) to the exterior of the device (100).

The flow control means is primarily actuated whenever the temperature sensor (210) detects that the temperature within the chamber (150) is above the required low value, which indirectly indicates that the level of cryogen liquid in the reservoir (200) is below the required level to provide the required temperature within the chamber. The flow control means is then shut off when the required temperature is restored through temperature data obtained from the temperature sensor (210). A maximum quantity of liquid cryogen within the reservoir (200) is detected by the level sensor (220), and the fill cycle is shut off when the level in the reservoir (200) is detected by the level sensor (220) irrespective of the data signal derived from the temperature sensor (210). The high level or overfill sensor (220) in effect is acting as an override to the temperature sensor (210). In one embodiment the high level sensor (220) may be used in conjunction with a low level sensor (not shown). Thus, by selectively actuating and shutting off the flow control means and permitting the liquid cryogen material to flow from the storage unit (not shown) and to the reservoir (200) via filling means (250) the liquid cryogen level in the reservoir (200) is maintained between predetermined maximum and minimum amounts.

Although the level sensor (220) and associated control electronics may use any conventional means to determine the liquid cryogen level within the reservoir (200), the sensor (220) and controller may actuates the control unit as a function of the barometric pressure within the reservoir (200). This barometric pressure varies as a function of the liquid level in the reservoir (200).

In practice, the reservoir (200) is partially filled with liquid cryogen. Cryogen vapours from the liquid cryogen contained in the reservoir (200) continuously exhaust through the top of the reservoir (200) and preferably into the chamber (150) thus aiding in cooling not only the chamber (150) but also biological specimens contained within the chamber (150). As the cryogen liquid is continuously being lost from the reservoir (200) and chamber (150) as cryogen vapour, the reservoir (200) is periodically refilled to maintain the liquid cryogen level in the reservoir (200) so that the liquid cryogen in the reservoir (200) and cryogen vapour cools the chamber (150) and any biological specimens contained in the chamber (150).

If the level of liquid cryogen in the reservoir (200) would fall then the temperature within the chamber would rise putting the viability of biological samples at risk. In these circumstances the temperature detected by the temperature sensor (210) in the chamber (150) will have risen above the required temperature and this will cause the control unit for the flow control means to initiate filling of the reservoir (200) with liquid cryogen. When the cryogenic storage device comprises a high and low level sensing combination the temperature sensor (210) circuit initiates activation of the flow control means to initiate filling of the reservoir (200) on failure of the low level sensor, thus acting as a backup for the low level sensor, although in normal circumstances the temperature sensor (210), as the primary controller of the fill cycle, would have initiated a fill cycle before the low level had been reached.

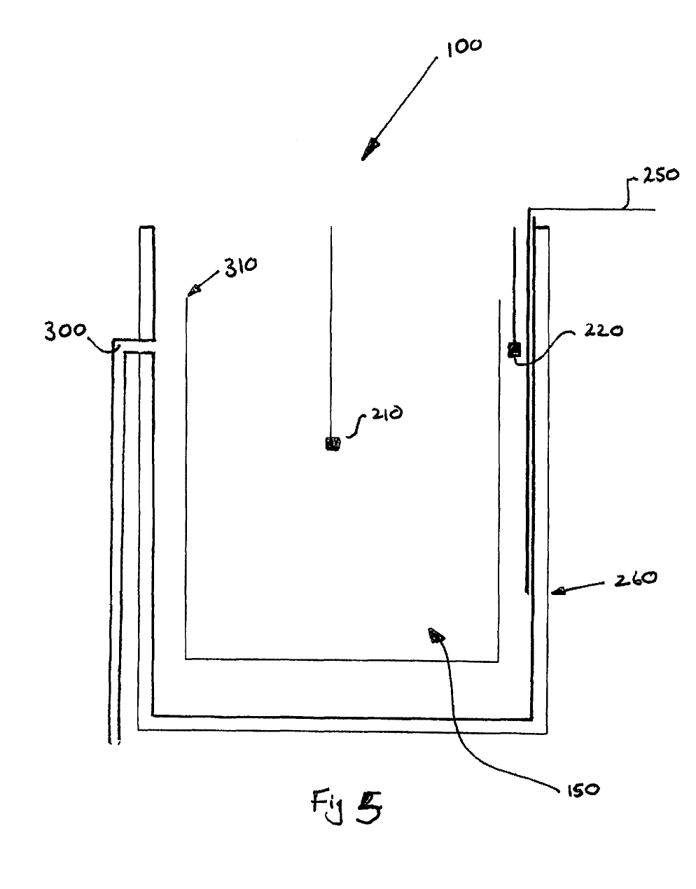

It is preferred that the device (100) of the present invention further comprises an overflow (300) associated with the cryogen fluid reservoir (200), which ensures that overfill of liquid cryogen above the height of the fluid reservoir (200) is not possible. One suitable arrangement is illustrated in FIG. 5, where it can be seen that the simple overflow (300) is located at a height above that of the level sensor (220) but below the top (310) of the fluid reservoir (200). If the sensor (220) fails liquid cryogen will fill the reservoir (200) and will pass out of the overflow (300) before it reaches the top (310) of the reservoir (200) thus ensuring that no liquid cryogen may enter the chamber (150). The excess liquid cryogen passes out of the overflow (300) into the ambient environment.

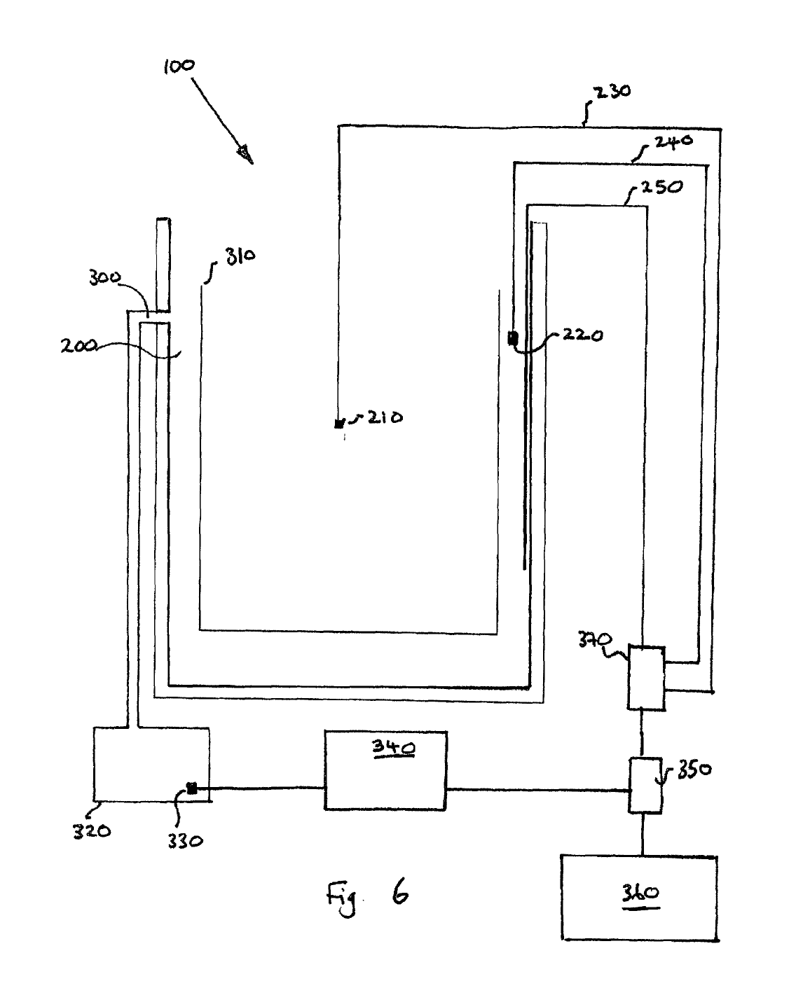

A preferred arrangement with reference to the overflow (300) is illustrated in FIG. 6. In this arrangement the device (100) of the present invention further comprises an overflow (300) associated with the cryogen fluid reservoir (200), which ensures that overfill of liquid cryogen above the height of the fluid reservoir (200) is not possible. The overflow (300) is located at a height above that of the level sensor (220) but below the top (310) of the fluid reservoir (200). If the level sensor (220) fails liquid cryogen will fill the reservoir (200) and will pass out of the overflow (300) before it reaches the top (310) of the reservoir (200) thus ensuring that no liquid cryogen may enter the chamber (150). The cryogen liquid will pass through the overflow (300) and into an overflow chamber (320), which comprises a liquid cryogen detector (330). When liquid cryogen is detected by the detector (330) the signal from this sensor will, through an independent electronic control system (340), actuate an independent safety valve (350), which is connected to the liquid cryogen supply source (360) in order to safely shut off the supply of liquid cryogen through line (250) into the fluid reservoir (200) in the device (100). The overflow electronic control system (340) acts independently of the normal control system (not shown) for the automated cryogen filling system of the present invention, which fills the device (100) through shut off valve (370) under control from the temperature sensor (210) or the level sensor (220).

The independent electronic control system (340) preferably has an independent emergency power supply so that in the event of mains failure this system will continue to operate for a period of time after power failure, which may be as long as four weeks.

In a preferred embodiment activation of the cryogen liquid detector (330) and/or the independent safety valve (350) is associated with an alarm to alert operators or monitors of the system that the fill sensor has failed resulting in a cryogen overflow event.

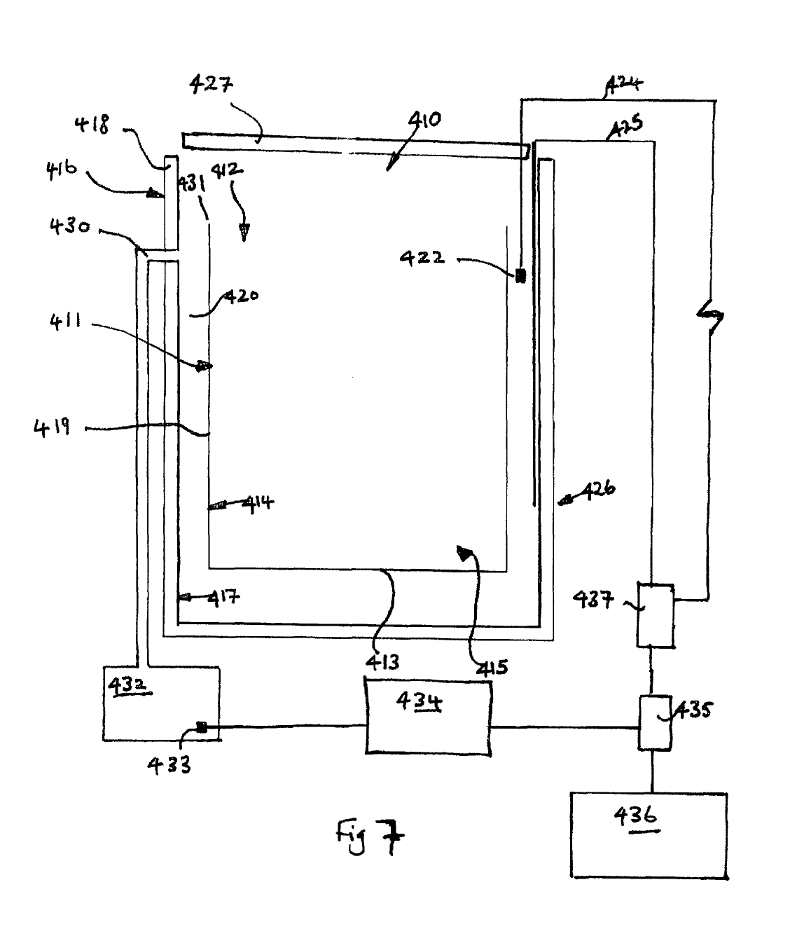

With reference to FIG. 7, there is exemplified a cryogenic storage device (410) including the overflow control system of the present invention. The cryogenic storage device (410) comprises a tank (411) which is generally cylindrical in shape. The tank (411) includes an open top (412) and a closed bottom (413).

The tank (411) includes an inner wall (414) which defines a generally cylindrical interior chamber (415) adapted to receive biological specimens. Such biological specimens are inserted into and removed from the chamber (415) through the open tank top (412) and are held in conventional cryogenic trays. The specimens are typically frozen prior to their insertion into the chamber (415).

The tank (411) is secured (not shown) within a double walled container (416) having an inner wall (417) and a vacuum space (418). The tank (411) is secured in such a fashion that its outer surface (419) defines a space (420) with the inner wall (417) of the double walled container (416). This space (420) acts as a cryogen fluid reservoir. This reservoir (420) extends entirely circumferentially around the sides of the chamber (415) as well as the bottom of the chamber (415).

The reservoir (420) is open at its top enabling fluid communication with the chamber (415). With reference to FIG. 7, a lid (427) is preferably disposed across the open top (412) of the device (410) at all times except when biological specimens are introduced into or removed from the chamber (415). This lid (427), in the conventional fashion, may not form an airtight seal but allows a continuous flow of cryogen vapour from the chamber (415) to the exterior of the device (410).

The device (410) further comprises a cryogen liquid level sensor (422) located within the reservoir (420) and located at a height required for the cryogenic liquid (not shown) when present in the reservoir (420). The level sensor (422) is connected to an electronic monitoring and control unit (not shown) via connection (424), which is connected to a means (not shown) for actuating cryogen liquid flow control means (not shown) in response to data obtained from the level sensor (422). The flow control means controls the flow of liquid cryogen from a liquid cryogen storage unit (not shown) into the device (410) via liquid cryogen filling means (425), which fills the reservoir (420) from a point (426), which is below the level sensor (422).

The flow control means is primarily actuated whenever the fluid level in the reservoir (420) is below a predetermined amount as detected by the level sensor (422), and is shut off when the required level in the reservoir (420) is returned to the required level. In one embodiment the level sensor (422) comprises high and low liquid cryogen level detection capabilities. Thus, by selectively actuating and shutting off the flow control means and permitting the liquid cryogen material to flow from the storage unit (not shown) and to the reservoir (420) via filling means (425) the liquid cryogen level in the reservoir (420) is maintained between predetermined maximum and minimum amounts.

Although the level sensor (422) and associated control electronics may use any conventional means to determine the liquid cryogen level within the reservoir (420), the sensor (422) and controller may actuate the control unit as a function of the barometric pressure within the reservoir (420). This barometric pressure varies as a function of the liquid level in the reservoir (420).

In practice, the reservoir (420) is partially filled with liquid cryogen. Cryogen vapours from the liquid cryogen contained in the reservoir (420) continuously exhaust through the top of the reservoir (420) and preferably into the chamber (415) thus aiding in cooling not only the chamber (415) but also biological specimens contained within the chamber (415). As this vapour is continuously being lost from the reservoir (420) as cryogen vapour, the reservoir (420) is periodically refilled to maintain the liquid cryogen level in the reservoir (420) within predetermined threshold amounts so that the liquid cryogen in the reservoir (420) cools the interior chamber (415) and any biological specimens contained in the chamber (415).

If the level sensor (422) should fail or become faulty the level of liquid cryogen in the reservoir (420) could rise within the chamber or fluid reservoir and entering the chamber putting the viability of biological samples at risk.

A preferred arrangement with reference to the overflow system of the present invention is illustrated in FIG. 7. In the present invention this risk is nullified in device (410) by means of an overflow (430) associated with the cryogen fluid reservoir (420), which ensures that overfill of liquid cryogen above the height of the fluid reservoir (420) is not possible. It can be seen that the simple overflow (430) is located at a height above that of the level sensor (422) but below the top (431) of the fluid reservoir (420). If the sensor (422) fails liquid cryogen will fill the reservoir (20) and will pass out of the overflow (430) before it reaches the top (431) of the reservoir (420) thus ensuring that no liquid cryogen may enter the chamber (415). In an arrangement where the liquid cryogen occupies a space in the chamber below the biological samples the overflow is located below the sample support.

In the arrangement of FIG. 7, the device (410) comprises an overflow (430) associated with the cryogen fluid reservoir (420), which ensures that overfill of liquid cryogen above the height of the fluid reservoir (420) is not possible. The cryogen liquid will pass through the overflow (430) and into an overflow chamber (432), which comprises a liquid cryogen detector (433). When liquid cryogen is detected by the detector (433) the signal from this sensor will, through an independent electronic control system (434), actuate an independent safety valve (435), which is connected to the liquid cryogen supply source (436) in order to safely shut off the supply of liquid cryogen through line (425) into the fluid reservoir (420) in the device (410). The overflow electronic control system (434) acts independently of the normal control system (not shown) for the automated cryogen filling system of the present invention, which fills the device (410) through shut off valve (437) under control from the level sensor (422).

The independent electronic control system (434) preferably has an independent emergency power supply so that in the event of mains failure this system will continue to operate for a period of time after power failure, which may be as long as four weeks.

In a preferred embodiment activation of the cryogen liquid detector (433) and/or the independent safety valve (435) is associated with an alarm to alert operators or monitors of the system that the fill sensor has failed resulting in a cryogen overflow event.

Thus with this overflow system, even in the event of total overflow, the system will safely protect the biological samples from damage and contamination and, as importantly, will also protect the surrounding environment, personal and property within the vicinity of the cryogenic device from the liquid cryogen.

All of the features disclosed in this specification for each and every embodiment and arrangement (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A cryogenic device comprising a cryogenic chamber, a liquid cryogen reservoir and/or an injection zone for liquid cryogen, separated by an insulator.

2. The cryogenic device as claimed in claim 1 wherein the insulator is a multi-layered plate insulator comprising two or more plates.

3. The cryogenic device as claimed in claim 1 comprising a source of heat.

4. The cryogenic device as claimed in claim 1 comprising temperature measuring means.

5. The cryogenic device as claimed in claim 1 comprising means for controlling the injection of liquid cryogen into the injection zone for liquid cryogen.

6. The cryogenic device as claimed in claim 5, wherein the means for controlling the injection of liquid cryogen into the injection zone for liquid cryogen is in response to temperature data obtained from the temperature measuring means.

7. The cryogenic device as claimed in claim 3, wherein the source of heat is an electric heater.

8. The cryogenic device as claimed in claim 3, wherein the source of heat is a second liquid cryogen of higher temperature or a higher temperature gas.

9. The cryogenic device as claimed in claim 3 comprising means for controlling the application of heat from the heat source.

10. The cryogenic device as claimed in claim 7, wherein the means for controlling the application of heat from the heat source is in response to temperature data obtained from the temperature measuring means.

11. The cryogenic device as claimed in claim 3, wherein the device features and controls are combined into an integrated device control system.

12. A cryogenic device comprising a cryogenic chamber, temperature measuring means, a liquid cryogen injection zone, a source of heat, and means for controlling, in response to temperature data obtained from the temperature measuring means, the injection of liquid cryogen into the injection zone and the application of heat, to control the temperature in the cryogenic chamber.

13. The cryogenic device as claimed in claim 12 further comprising a multi-layered plate insulator.

14. The cryogenic device as claimed in claim 12, wherein the means for controlling the injection of liquid cryogen into the injection zone for liquid cryogen is in response to temperature data obtained from the temperature measuring means.

15. The cryogenic device as claimed in claim 12, wherein the source of heat is an electric heater.

16. The cryogenic device as claimed in claim 12, wherein the source of heat is a second liquid cryogen of higher temperature or a higher temperature gas.

17. The cryogenic device as claimed in claim 12, comprising means for controlling the application of heat from the heat source.

18. The cryogenic device as claimed in claim 12, wherein the device features and controls are combined into an integral device control system.

19. A method of refrigeration or freezing, which comprises monitoring the temperature within a cryogenic device comprising liquid cryogen injection means and a heat source and using the temperature monitoring to control the relative amount of liquid cryogen injected and heat to be applied to the cryogenic device in order to adjust the temperature within the cryogenic device to a desired value.

20. The device as claimed in claim 18, wherein the temperature sensors are located within the cryogenic chamber of device.

21. An automated cryogen filling system, which comprises means for controlling the flow of cryogen from a cryogen store into a cryogenic refrigerator, temperature sensing means for sensing the temperature within a cryogenic refrigerator, cryogen level monitoring means for detecting the level of cryogen within a cryogenic refrigerator, and means for actuating the flow control means in response to data obtained from the temperature sensing means or cryogen level monitoring means.

22. A cryogenic storage device comprising the automated cryogen filling system according to claim 21.

23. The cryogen storage device as claimed in claim 22 further comprising a tank having an open top and a wall which defines an interior cryogenic freezing chamber, adapted to receive biological specimens, means for supporting biological samples within the chamber above the floor of the chamber, a source of cryogen fluidly connected to the interior of the chamber, and means for introducing the cryogen to provide a liquid cryogen level within the chamber that is below the level of storage of the biological specimens to be frozen.

24. The cryogen storage device as claimed in claim 22 further comprising an interior chamber and a fluid reservoir arranged such that it forms an envelope of cryogen around the interior chamber such that there is no fluid communication between the fluid reservoir and the interior chamber, a source of cryogen fluidly connected to the interior of the fluid reservoir, and means for introducing the cryogen to provide a liquid cryogen level within the fluid reservoir that may be above or below the level of storage of the biological specimens to be frozen within the chamber.

25. The cryogen storage device as claimed in claim 22 further comprising a tank having an open top and a wall closed at its lower end, which defines an interior chamber adapted to receive biological specimens, a fluid reservoir disposed around at least a portion of the wall on an outer surface of the wall and adapted to receive a liquid cryogen at least one vent located proximate to the top of the interior wall to permit fluid communication between the fluid reservoir and the interior chamber of the storage device.

26. An automated cryogen filling system as claimed in claim 21, wherein the temperature sensor is located within the sample chamber of the cryogenic device.

27. The automated cryogen filling system as claimed in claim 21, wherein the temperature sensor comprises a plurality of sensors located within the sample chamber of the cryogenic device.

28. The automated cryogen filling system as claimed in claim 21, wherein the temperature sensor provides the primary fill control data for actuating the flow control means.

29. The cryogen storage device as claimed in claim 22, which further comprises a cryogen liquid overflow system comprising a cryogen liquid overflow, which prevents cryogen liquid in excess of that required from accumulating in the cryogenic chamber or fluid reservoir.

30. A method for automated cryogen filling of a cryogenic device comprising means for controlling the flow of cryogen from a cryogen store into a cryogenic refrigerator, temperature sensing means for sensing the temperature within a cryogenic refrigerator, cryogen level monitoring means for detecting the level of cryogen within a cryogenic refrigerator, and means for actuating the flow control means, in which method the temperature of the cryogenic device and the level of liquid cryogen in the device are monitored and actuation of the flow control means is initiated in response to data obtained from the temperature sensing means or cryogen level monitoring means.

31. A cryogen storage device comprising a cryogen liquid overflow system comprising a cryogen liquid overflow in fluid communication with an overflow chamber, which comprises liquid cryogen sensing means.

32. The cryogen storage device as claimed in claim 31, wherein the cryogen sensing means cooperates with an in independent safety valve connected to cryogen liquid feed means between the cryogen storage and the cryogenic device.

33. The cryogen storage device as claimed in claim 31 further comprising a tank having an open top and a wall which defines an interior cryogenic freezing chamber, adapted to receive biological specimens, means for supporting biological samples within the chamber above the floor of the chamber, a source of cryogen fluidly connected to the interior of the chamber, and means for introducing the cryogen to provide a liquid cryogen level within the chamber that is below the level of storage of the biological specimens to be frozen.

34. The cryogen storage device as claimed in claim 31 further comprising an interior chamber and a fluid reservoir arranged such that it forms an envelope of cryogen around the interior chamber such that there is no fluid communication between the fluid reservoir and the interior chamber, a source of cryogen fluidly connected to the interior of the fluid reservoir, and means for introducing the cryogen to provide a liquid cryogen level within the fluid reservoir that may be above or below the level of storage of the biological specimens to be frozen within the chamber.

35. The cryogen storage device as claimed in claim 31 further comprising a tank having an open top and a wall closed at its lower end, which defines an interior chamber adapted to receive biological specimens, a fluid reservoir disposed around at least a portion of the wall on an outer surface of the wall and adapted to receive a liquid cryogen at least one vent located proximate to the top of the interior wall to permit fluid communication between the fluid reservoir and the interior chamber of the storage device.

36. The cryogenic device as claimed in claim 1, further comprising means for controlling the flow of cryogen from a cryogen store into a cryogenic refrigerator, temperature sensing means for sensing the temperature within a cryogenic refrigerator, cryogen level monitoring means for detecting the level of cryogen within a cryogenic refrigerator, and means for actuating the flow control means in response to data obtained from the temperature sensing means or cryogen level monitoring means.

37. The cryogenic device as claimed in claim 1, further comprising a cryogen liquid overflow system comprising a cryogen liquid overflow in fluid communication with an overflow chamber, which comprises liquid cryogen sensing means.
